(19) United States
(12) Patent Application Publication
(10) Pub. No.: US 2020/0249820 A1
(43) Pub. Date: Aug. 6, 2020

(54) ELECTRONIC DEVICE AND OPERATION METHOD THEREFOR

(71) Applicant: Samsung Electronics Co., Ltd., Suwon-si, Gyeonggi-do (KR)

(72) Inventors: Jihyun CHOI, Seoul (KR); Byungjin KANG, Seoul (KR); Gwanyoung YOO, Seoul (KR); Yusun CHEONG, Seongnam-si (KR); Byengseok CHOI, Yongin-si (KR)

(21) Appl. No.: 15/774,475

(22) PCT Filed: Nov. 4, 2016
(86) PCT No.: PCT/KR2016/012622

§ 371 Date: May 8, 2018

(30) Foreign Application Priority Data
Nov. 9, 2015 (KR) 10-2015-0156792

(51) Int. Cl. G06F 3/0481; G06F 3/0488; G06F 3/01; G06F 9/54; G06F 9/451

(52) U.S. Cl. CPC G06F 3/04817; G06F 3/0488; G06F 9/543; G06F 9/542; G06F 9/451; G06F 3/013

(57) ABSTRACT

Various embodiments of the present disclosure relate to an electronic device and an operating method thereof. The method may include detecting occurrence of a notification event, displaying a notification window for the detected notification event at a designated position of a display screen, identifying an input detected in the electronic device, and controlling the notification window in the display screen in accordance with the input, and may also be applicable to other embodiments.

### TECHNICAL FIELD

Various embodiments of the present disclosure relate to an electronic device and an operating method thereof.

### DESCRIPTION OF RELATED ART

With the spread of an electronic device equipped with a touch screen, various content such as a website, image data, video data, or the like can be identified by using the electronic device. A size of the electronic device tends to be increased to more clearly identify the various content.

Upon occurrence of a notification event such as a text message, application update, e-mail reception, schedule alarm, or the like, the electronic device displays a notification (or pop-up) window at a specific position of the electronic device to notify the occurrence of the notification event to a user. However, due to the increase in the size of the electronic device, inconveniently, the user may need to use both hands to select the displayed notification window.

### DETAILED DESCRIPTION OF THE INVENTION

### Technical Problem

When a notification event occurs in an electronic device as described above, a user inconveniently manipulates the electronic device with both hands to execute the notification event.

In order to solve the conventional problem, various embodiments of the present disclosure provide an electronic device capable of controlling a notification window for informing occurrence of a notification event when the notification event occurs in the electronic device, and an operating method thereof.

### Technical Solution

A method of operating an electronic device according to an embodiment of the present disclosure may include detecting occurrence of a notification event, displaying a notification window for the detected notification event at a designated position of a display screen, identifying an input detected in the electronic device, and controlling the notification window in the display screen in accordance with the input.

An electronic device according to an embodiment of the present disclosure may include a display which displays a display screen, and a controller which detects occurrence of a notification event, displays a notification window for the notification event at a designated position of a display screen, identifies an input detected in the electronic device, and controls the notification window in the display screen in accordance with the input.

### Advantageous Effects

As described above, an electronic device and an operating method thereof according to an embodiment of the present disclosure can control a notification window for informing occurrence of a notification event in accordance with a user input when the notification event occurs in the electronic device.

### BRIEF DESCRIPTION OF THE DRAWINGS

FIG. 1 is a block diagram illustrating an electronic device according to an embodiment of the present disclosure;

FIG. 2 is a flowchart illustrating an operating method of an electronic device according to an embodiment of the present disclosure;

FIG. 3 is a flowchart illustrating an operating method of controlling a notification window in an electronic device according to an embodiment of the present disclosure;

FIG. 4 is a flowchart illustrating an operating method of executing a notification window in an electronic device according to an embodiment of the present disclosure;

FIG. 5 illustrates an exemplary screen of an electronic device for controlling a notification window on the basis of a grip of the electronic device according to an embodiment of the present disclosure;

FIG. 6 illustrates an exemplary screen of an electronic device for controlling a notification window by manipulating a flexible electronic device according to an embodiment of the present disclosure;

FIG. 7 illustrates an exemplary screen of an electronic device for controlling a notification window by manipulating an input unit of the electronic device according to an embodiment of the present disclosure;

FIG. 8 illustrates an exemplary screen of an electronic device for executing a notification window on the basis of a tilt of the electronic device according to an embodiment of the present disclosure;

FIG. 9 illustrates an exemplary screen of an electronic device for executing a notification window on the basis of a user's gaze movement according to an embodiment of the present disclosure;

FIG. 10 illustrates an exemplary screen of an electronic device for executing a notification window in accordance with an input achieved in a specific sensor of the electronic device according to an embodiment of the present disclosure;

FIG. 11 illustrates an exemplary screen of an electronic device for controlling a notification window on the basis of a tilt and grip of the electronic device according to an embodiment of the present disclosure; and

FIG. 12 illustrates an exemplary screen of an electronic device for controlling a notification window on the basis of a user's gaze movement and a grip of the electronic device according to an embodiment of the present disclosure.

### MODE FOR CARRYING OUT THE INVENTION

Embodiments of the present disclosure will be described herein below with reference to the accompanying drawings. In this case, it should be noted that like reference numerals denote like constitutional elements in the accompanying drawings. In the following description, well-known functions or constructions are not described in detail since they would obscure the disclosure in unnecessary detail.

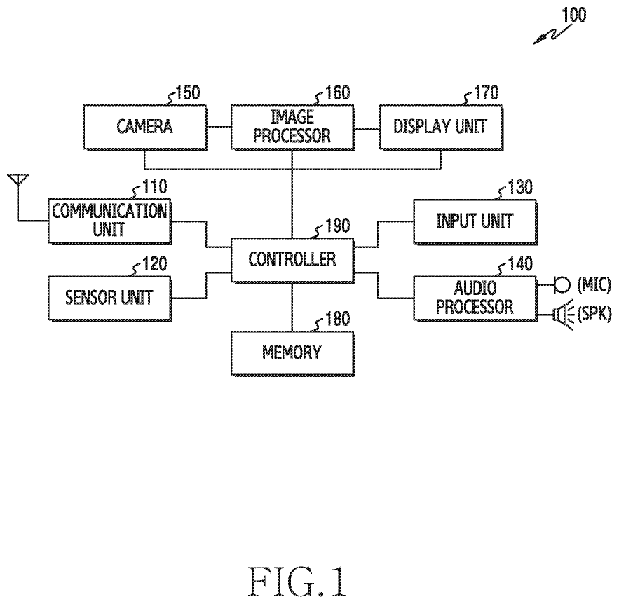

FIG. 1 is a block diagram illustrating an electronic device according to an embodiment of the present disclosure.

Referring to FIG. 1, an electronic device 100 according to an embodiment of the present disclosure may include a communication unit 110, a sensor unit 120, an input unit 130, an audio processor 140, a camera 150, an image processor 160, a display unit 170, a memory 180, and a controller 190.

The communication unit 110 may perform communication with at least one external device (not shown) including a portable electronic device such as a smart phone, a tablet, or the like and an electronic device such as a laptop or the like. In this case, the communication unit 110 may communicate with the external device by using various communication schemes. The communication unit 110 may perform at least any one of wireless communication and wired communication. The communication unit 110 may access at least any one of a mobile communication network and a data communication network. For example, the external electronic device may include an electronic device, a base station, a server, and a satellite. The communication scheme may include Long Term Evolution (LTE), Wideband Code Division Multiple Access (WDCMA), Global System for Mobile Communications (GSM), Wireless Fidelity (WiFi), Bluetooth, Near Field Communications (NFC), and an Infrared Ray (IR).

The sensor unit 120 may measure, for example, physical quantity or detect an operational status of the electronic device 100, and may convert the measured or detected information into an electric signal. The sensor unit 120 may include, for example, at least one of a gesture sensor, a gyro sensor, an atmospheric pressure sensor, a magnetic sensor, an acceleration sensor, a grip sensor, a proximity sensor, a color sensor (e.g., a Red, Green, Blue (RGB) sensor), a biometric sensor, a temperature/humidity sensor, an illumination sensor, and an Ultra Violet (UV) sensor.

In particular, the sensor unit 120 may transmit a grip state of the electronic device 100 and a tilt change of the electronic device 100, which are caused depending on a user's operation, to the controller 190. In addition, a specific sensor (e.g., an illumination sensor, a pressure sensor, etc.) included in the sensor unit 120 may be disposed to a rear side of the electronic device 100. The specific sensor may transmit to the controller 190 an execution signal input from the user to execute a notification event. Additionally or alternatively, the sensor unit 120 may include, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor unit 120 may further include a control circuit for controlling at least one or more sensors included therein.

The input unit 130 may generate input data in response to a user input of the electronic device 100. The input unit 130 may include at least one input means. The input unit 130 may include a key pad, a dome switch, a touch panel, a jog & shuttle, a sensor, a touch key, and a button including a home button and a volume up/down button.

The audio processor 140 may process an audio signal. In this case, the audio processor 140 may include a speaker (SPK) and a microphone (MIC). The audio processor 140 may reproduce an audio signal output from the controller 190 through the speaker. The audio processor 140 may transmit the audio signal output from the microphone to the controller 190. The audio processor 140 may bi-directionally convert, for example, a sound and electric signal. The audio processor 140 may process sound information which is input or output through, for example, the speaker, the microphone, or the like.

The camera 150 may be disposed to front and rear sides of the electronic device 100 to acquire image data for a subject. For this, the camera 150 may receive an optical signal. The camera 150 may generate the image data from the optical signal. The camera 150 may include a camera sensor and a signal converter. The camera sensor may convert the optical signal into an electrical image signal. The signal converter may convert an analog image signal into digital image data. In particular, the camera disposed to the front side of the electronic device 100 may acquire image data for a user's face.

The image processing unit 160 processes image data. In this case, the image processing unit 160 may process the image data in unit of frames to output the data in association with characteristics and size of the display unit 170. Herein, the image processing unit 160 may compress the image data in a determined manner, or may restore the compressed image data into original image data.

The display unit 170 may output display data according to the operation of the electronic device 100. The display unit 170 may include a Liquid Crystal Display (LCD), a Light Emitting Diode (LED) display, an Organic Light-Emitting Diode (OLED) display, a Micro Electro Mechanical System (MEMS) display, and an electronic paper display. The display unit 170 may be implemented in a touch screen by being coupled to the input unit 130.

The memory 180 may store operational programs of the electronic device 100. For this, the memory 180 may include, for example, an internal memory or an external memory. The internal memory may include, for example, at least one of a volatile memory (e.g., a Dynamic RAM (DRAM), a Static RAM (SRAM), a Synchronous Dynamic RAM (SDRAM), etc.) and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory, a NOR flash memory, etc.), a hard drive, or a Solid State Drive (SSD)). The external memory may further include a flash drive, for example, Compact Flash (CF), Secure Digital (SD), Micro Secure Digital (Micro-SD), Mini Secure digital (Mini-SD), extreme Digital (xD), Multi-Media Card (MMC), memory stick, or the like. The external memory may be operatively and/or physically coupled with the electronic device via various interfaces.

The controller 190 may detect the occurrence of the notification event, and may display a notification window related to the notification event at a designated position of a display screen. The controller 190 may control the notification window in accordance with an input by identifying the input achieved in a state where the notification window is displayed on the display screen.

Upon detecting the occurrence of the notification event, the controller 190 may display a notification (or pop-up) window for the notification event at the designated position of the display screen. In this case, the display screen may be an idle screen, application execution screen, or the like displayed on the display unit 170. When an input for controlling the notification window occurs in a state where the notification window is displayed, the controller 190 may identify the input. In this case, the input may be a movement input for moving the notification window or an execution input for executing the notification window. In this case, the notification event may include a text message reception notification, an application related notification, a goods transfer completion notification, a social network service related notification, a telephone reception notification, a schedule alarm related notification, or the like. The notification event may include a notification event associated with a call received from another electronic device, various notification events received from an external server, and a notification event occurring in the electronic device 100.

According to an embodiment, when the input is the movement input, the controller 190 may display the notification window by changing a position of the notification window displayed at the designated position of the display screen. When the position of the notification window is changed, the controller 190 may change a size of the notification window, or may display the notification window by changing it in an icon shape. In this case, the controller 190 may detect any one of pressure detected by at least one pressure sensor disposed to a lateral side of the electronic device 100, grip detection of the electronic device 100, and an input achieved in a physical key (e.g., a volume up/down button) disposed to the lateral side of the electronic device 100. Further, when the electronic device 100 is a flexible electronic device, the controller 190 may detect any one of flipping detected in the electronic device 100 and the input achieved in the physical key disposed to the lateral side of the electronic device 100 as the movement input.

According to an embodiment, when the input is the execution input, the controller 190 may perform a function corresponding to the notification event. In this case, the controller 190 may detect any one of a change in a tilt of the electronic device 100 and a user's gaze movement as the execution input. Further, the controller 190 may detect an execution signal, which is input from a sensor disposed to a rear side of the electronic device, for the notification window as the execution input.

The controller 190 may identify the tilt of the electronic device 100 at a time when the notification event occurs, and when there is a change in the tilt within a threshold time, may perform a function corresponding to the tilt. For example, when a lower portion of the electronic device 100 is tilted toward the user, the controller 190 may end the displaying of the notification window. When an upper portion of the electronic device 100 is tilted toward the user, the controller 190 may perform the function corresponding to the notification event. Further, when the tilt of the electronic device 100 is changed to the left/right, the controller 190 may move the notification window to the left/right, or may perform the function of the notification event.

The controller 190 may activate the camera 150 disposed to a front side of the electronic device 100 at a time when the notification event occurs. The controller 190 may identify user's image data acquired from the camera 150 to identify a user's gaze movement direction. The controller 190 may compare the user's gaze direction at the time when the notification event occurs and the user's gaze direction identified within the threshold time. The controller 190 may end the displaying of the notification window when the user's gaze direction is changed towards an upper side of the electronic device 100. The controller 190 may perform the function corresponding to the notification event when the user's gaze direction is changed towards a lower side of the electronic device 100. In addition, the controller 190 may move the notification window to the left/right or may perform the function of the notification event when the user's gaze movement is changed to the left/right.

The controller 190 may perform a function of displaying a text message on the display unit 170 when the notification event is the text message reception notification. The controller 190 may perform an application update function or the like when the notification event is the application related notification. The controller 190 may perform a bank application execution function when the notification event is the transfer completion notification. The controller 190 may perform a function of performing a social network service when the notification event is the social network service related notification. The controller 190 may perform a function of connecting a call with a caller when the notification event is the call reception notification. The controller 190 may perform a function of displaying a schedule screen on the display unit 170 when the notification event is the schedule alarm related notification. The controller 190 may display a screen of a function corresponding to the notification event on a display screen of a specific application in an overlaid manner when an execution input is detected while the specific application is executed.

According to an embodiment, the electronic device 100 based on the present disclosure may include the display unit 170 for displaying the display screen and the controller 190 for detecting occurrence of the notification event, displaying the notification window for the notification event at the designated position on the display screen, identifying an input detected in the electronic device 100, and controlling the notification window on the display screen in accordance with the input.

If the input is a movement input for the notification window, the controller 190 may move the notification window in accordance with the input. The controller 190 may decrease a size of the notification window while moving the notification window. The controller 190 may change the notification window to an icon while moving the notification window.

The movement input for the notification window may include any one of a finger position detected when the electronic device 100 is gripped, flipping occurring in the electronic device 100, and an input achieved by a physical key provided in the electronic device 100.

The controller 190 may perform the function corresponding to the notification event when the notification window is selected. The controller 190 may perform the function corresponding to the notification event when the input is the execution input for the notification window.

The execution input for the notification window may be a change in a tilt detected in the electronic device 100. The camera 150 for acquiring an image for the user may be further included, and the execution input for the notification window may be a change in a user's gaze movement identified from the image.

A sensor may be further included, and the controller 190 may perform the function corresponding to the notification event when the input is an execution signal detected in the sensor.

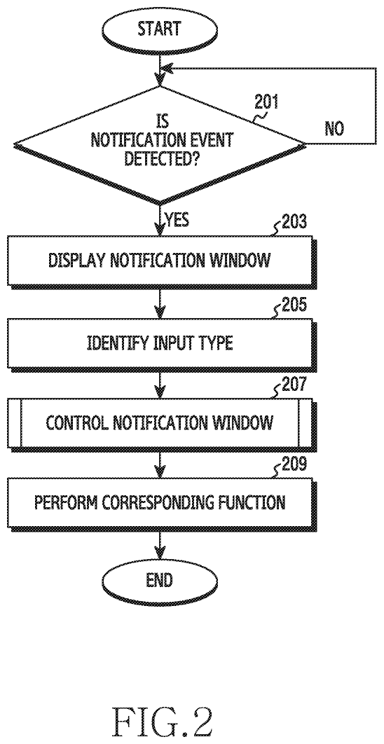

FIG. 2 is a flowchart illustrating an operating method of an electronic device according to an embodiment of the present disclosure.

Referring to FIG. 2, in operation 201, the electronic device 100 identifies whether a notification event is detected. When the notification event is detected in operation 201, the electronic device 100 may perform operation 203. When the notification event is not detected in operation 201, the electronic device 100 may repetitively perform operation 201. In this case, the notification event may include a text message reception notification, an application related notification, a transfer completion notification, a social network service related notification, a telephone reception notification, a schedule alarm related notification, or the like.

In operation 203, the electronic device 100 may display a notification window for the notification event. In this case, the notification window may be a pop-up window. The electronic device 100 may display the notification window at a designated position on the display screen. In this case, the display screen may be an idle screen displayed on the display unit 170, an execution screen of a specific application, or the like. In operation 205, the electronic device 100 may identify an input achieved in a state where the notification window is displayed on the display screen.

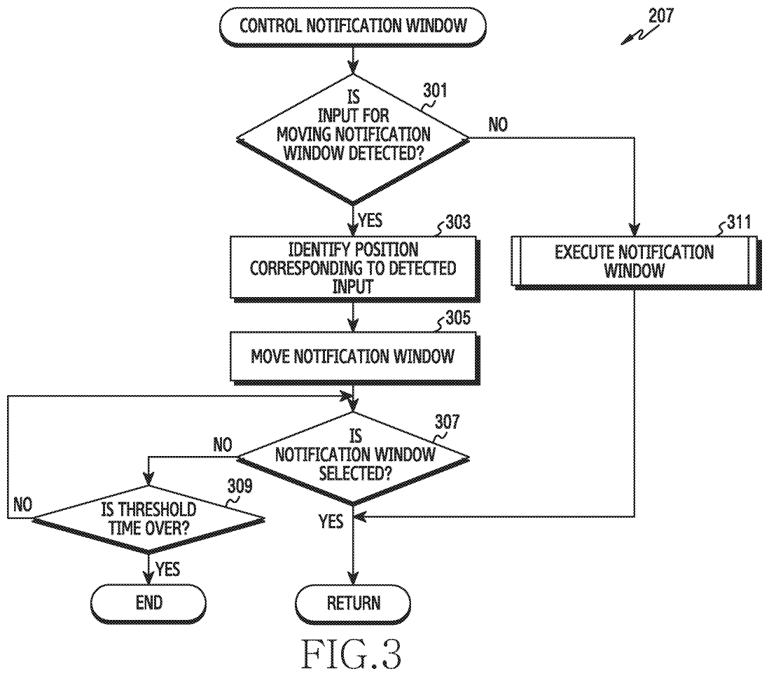

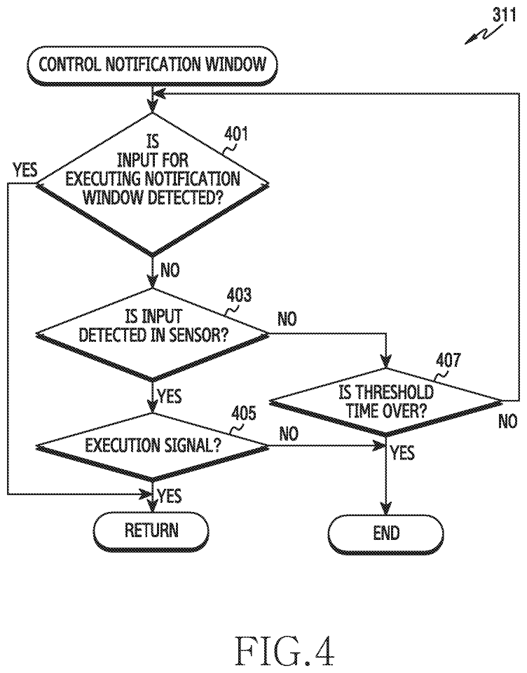

Upon identifying the input in operation 205, the electronic device 100 may perform operation 207. In operation 207, the electronic device 100 may control the notification window displayed on the display screen in accordance with the identified input. This will be described below in detail with reference to FIG. 3 and FIG. 4.

In operation 209, the electronic device 100 may perform the function corresponding to the notification event. The electronic device 100 may perform a function of displaying a text message on the display unit 170 when the notification event is the text message reception notification. The electronic device 100 may perform an application update function or the like when the notification event is the application related notification. The electronic device 100 may perform a bank application execution function when the notification event is the transfer completion notification. The electronic device 100 may perform a function of performing a social network service when the notification event is the social network service related notification. The electronic device 100 may perform a function of connecting a call with a caller when the notification event is the call reception notification. The electronic device 100 may perform a function of displaying a schedule screen on the display unit 170 when the notification event is the schedule alarm related notification.

FIG. 3 is a flowchart illustrating an operating method of controlling a notification window in an electronic device according to an embodiment of the present disclosure.

Referring to FIG. 3, in operation 301, the electronic device 100 may identify whether the input identified in operation 205 is a movement input for moving the notification window displayed on the display unit 170. In this case, the movement input may be any one of pressure detected by at least one pressure sensor disposed to a lateral side of the electronic device 100, grip detection of the electronic device 100, and an input achieved in a physical key (e.g., a volume up/down button) disposed to the lateral side of the electronic device 100. When the electronic device 100 is a flexible electronic device, the movement input may be any one of flipping detected in the electronic device 100 and the input achieved in the physical key disposed to the lateral side of the electronic device 100 as the movement input. When it is identified in operation 301 that the input identified in operation 205 is the movement input, the electronic device 100 may perform operation 303. When it is identified in operation 301 that the input identified in operation 205 is not the movement input, the electronic device 100 may perform operation 311. In operation 311, the electronic device 100 may execute the notification window. This will be described below in detail with reference to FIG. 4.

In operation 303, the electronic device 100 may identify a position corresponding to the movement input. In this case, the electronic device 100 may identify a position of a user's thumb when a grip (e.g., squeeze) of the electronic device 100 is detected. In this case, the electronic device 100 may detect the grip by means of a pressure sensor disposed to the electronic device 100, and may detect the grip by means of a grip sensor or the like. The electronic device 100 may identify whether flipping is detected. The electronic device 100 may identify a type of a physical key in which the input is achieved. The electronic device 100 may identify a type of the physical key in which the input is achieved and the number of times the input is achieved.

In operation 305, the electronic device 100 may display the notification window by moving it on the basis of the identified position. In this case, upon detecting the grip of the electronic device 100, the electronic device 100 may move the notification window to a position corresponding to the identified position of the user's thumb. Upon detecting occurrence of the flipping in the electronic device 100, the electronic device 100 may move the notification window. In this case, the electronic device 100 may move the notification window to a pre-set position (e.g., a lower end of the display unit 170), and may move the notification window to a position corresponding to the user's thumb position identified when the flipping occurs. When an input is achieved in the physical key, the electronic device 100 may identify the type of the physical key in which the input is achieved, and may move the notification window in a direction corresponding to the identified physical key. The electronic device 100 may move the notification window in a direction corresponding to the physical key by the number of times the input is achieved in the physical key.

When the moved and displayed notification window is selected in operation 307, the electronic device 100 may return to operation 209 of FIG. 2. When the notification window is not selected in operation 307, the electronic device 100 may perform operation 309. When a threshold time is over in operation 309 in a state where the notification window is not selected, the electronic device 100 may end the process. In this case, the end of the process may imply the end of displaying of the notification window. When the threshold time is not over in operation 309, the electronic device 100 may return to operation 307.

FIG. 4 is a flowchart illustrating an operating method of executing a notification window in an electronic device according to an embodiment of the present disclosure.

Referring to FIG. 4, in operation 401, the electronic device 100 may identify whether the input identified in operation 205 is an execution input for executing the notification window displayed in operation 203. In this case, the execution input may be any one of a tilt change of the electronic device and a user's gaze movement. When it is identified in operation 401 that the input identified in operation 205 is the execution input, the electronic device 100 may return to operation 209 of FIG. 2.

The electronic device 100 may identify the tilt of the electronic device 100 at a time when the notification event occurs, and when there is a change in the tilt within a threshold time, may perform a function corresponding to the tilt. For example, when a lower portion of the electronic device 100 is tilted toward the user, the electronic device 100 may end the displaying of the notification window. When an upper portion of the electronic device 100 is tilted toward the user, the electronic device 100 may perform a function corresponding to the notification event. Further, when the tilt of the electronic device 100 is changed to the left/right, the electronic device 100 may move the notification window to the left/right, or may perform a function of the notification event.

The electronic device 100 may activate the camera 150 disposed to a front side of the electronic device 100 at a time when the notification event occurs. The electronic device 100 may identify user's image data acquired from the camera 150 to identify a user's gaze movement direction. The electronic device 100 may compare the user's gaze direction at the time when the notification event occurs and a user's gaze direction identified within a threshold time. The electronic device 100 may identify a user's iris from user's image data to identify a movement direction of the iris during a threshold time, and thus may identify this as the gaze movement direction. The electronic device 100 may end the displaying of the notification window when the user's gaze direction is changed towards an upper side of the electronic device 100. The electronic device 100 may perform a function corresponding to the notification event when the user's gaze direction is changed towards a lower side of the electronic device 100. In addition, the electronic device 100 may move the notification window to the left/right or may perform the function of the notification event when the user's gaze movement is changed to the left/right.

When it is identified in operation 401 that the input identified in operation 205 is not the execution input, the electronic device 100 may perform operation 403. In operation 403, the electronic device 100 may identify whether an input is detected in a specific sensor disposed to a rear side of the electronic device 100. When it is identified in operation 403 that the input is detected in the specific sensor, the electronic device 100 may perform operation 405. When it is identified in operation 403 that the input to the specific sensor is not detected, the electronic device 100 may perform operation 407. When a time for which the execution input or the input to the specific sensor is not detected is greater than a threshold time in operation 407, the electronic device 100 may end the process. When the time for which the execution input or the input to the specific sensor is not detected is not greater than the threshold time in operation 407, the electronic device 100 may return to operation 401.

When it is identified in operation 405 that an input detected in the specific sensor is the execution signal, the electronic device 100 may perform operation 209 of FIG. 2. When it is identified in operation 405 that the input detected in the specific sensor is not the execution signal, the electronic device 100 may end the process.

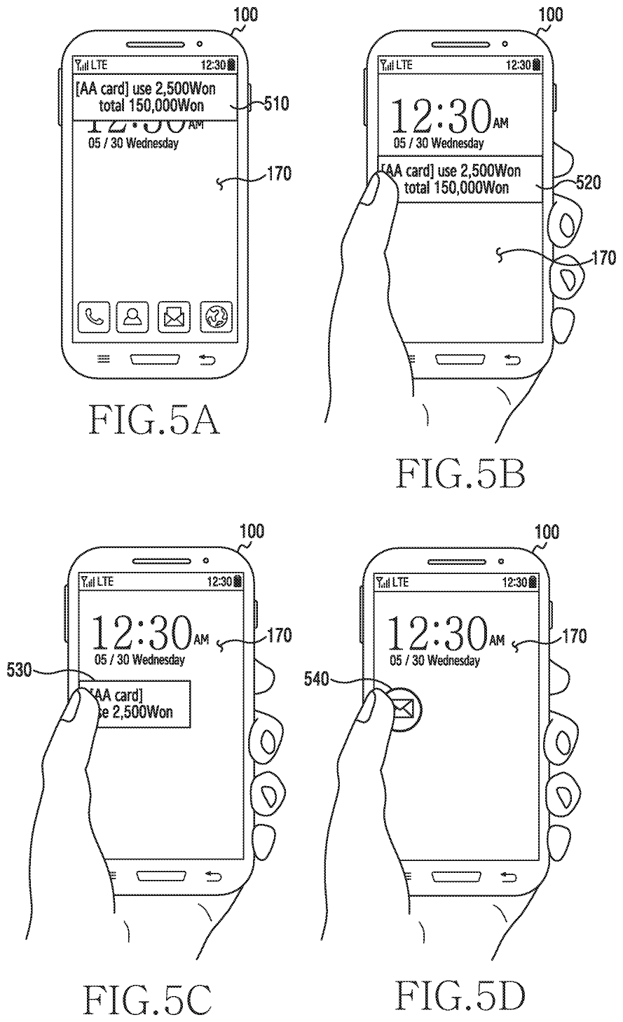

FIG. 5 illustrates an exemplary screen of an electronic device for controlling a notification window on the basis of a grip of the electronic device according to an embodiment of the present disclosure.

Referring to FIG. 5, when a notification event occurs to inform the use of a credit card in a state where an idle state is displayed on the display unit 170, the electronic device 100 may display a notification window 510 of the notification event at a designated position of the display unit 170 as shown in FIG. 5A. The electronic device 100 may identify that the electronic device 100 is gripped in a state where the notification window 510 is displayed. Upon detecting the grip of the electronic device 100, the electronic device 100 may identify that an input is a movement input for the notification window 510. In this case, the electronic device 100 may detect the grip when pressure greater than or equal to specific strength is applied to the electronic device 100 by means of at least one pressure sensor disposed to a lateral side of the electronic device 100. The electronic device 100 may detect the grip by means of a grip sensor or the like disposed to the electronic device 100.

The electronic device 100 may identify a thumb position when the electronic device 100 is gripped according to a movement input. As shown in FIG. 5B, the electronic device 100 may display a notification window 520 by moving it to the identified thumb position. As shown in FIG. 5C, the electronic device 100 may reduce and display a notification window 530 while moving it to the identified thumb position. As shown in FIG. 5D, the electronic device 100 may change and display the notification window 510 as an icon 540 while moving it to the identified thumb position. In this case, the displayed notification windows 510, 520, and 530 of FIG. 5A may display a part of content of a text message for a credit card usage history.

The electronic device 100 may execute a function of the notification event when the notification windows 510, 520, and 530 or the icon 540 are selected in FIGS. 5A to D. For example, since the notification event is the notification event for informing the use of the credit card, the electronic device 100 may display total content of the text message for the credit card history on the display unit 170.

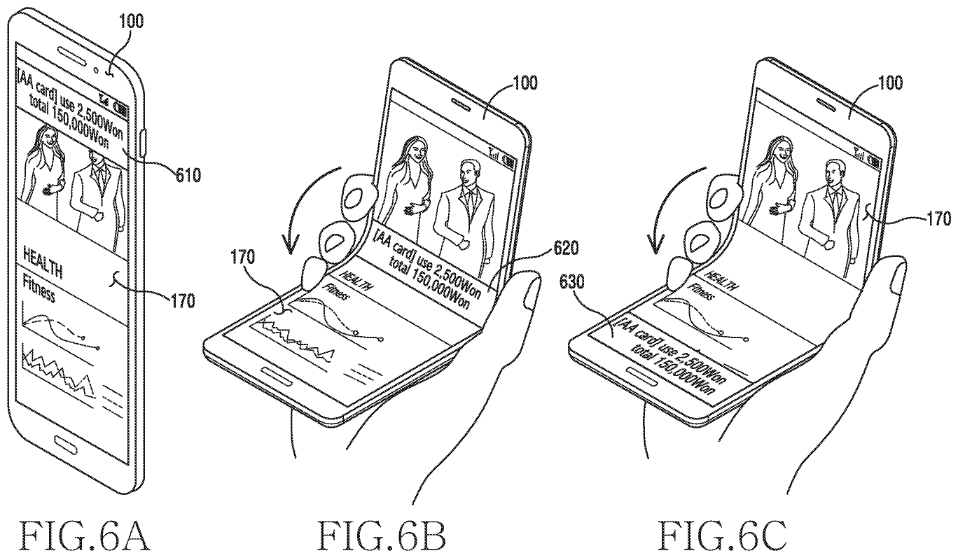

FIG. 6 illustrates an exemplary screen of an electronic device for controlling a notification window by manipulating a flexible electronic device according to an embodiment of the present disclosure.

Referring to FIG. 6, the electronic device 100 may be a flexible electronic device. The electronic device 100 may be constructed in a structure in which a part of the display unit 170 is folded. In this case, the electronic device 100 may be divided into upper and lower portions on the basis of a region to be folded. When the notification event for informing the credit card usage occurs in a state where a health related application execution screen is displayed on the display unit 170, as shown in FIG. 6A, the electronic device 100 may display a notification window 610 of the notification event at a designated position of the display unit 170.

The electronic device 100 may identify that flipping is detected in a portion of the display unit 170 (e.g., an upper portion of the electronic device 100) in a state where the notification window 610 is displayed. Upon detecting the flipping in the portion of the electronic device 100, the electronic device 100 may identify that the input is a movement input for the notification window 610. Upon detecting the flipping, the electronic device 100 may identify a thumb position of a user who grips the electronic device 100. As shown in FIG. 6B, the electronic device 100 may display a notification window 620 by moving it to the identified thumb position.

Upon detecting the flipping in the portion of the display unit 170 (e.g., the upper portion of the electronic device 100) in the state where the notification window 610 is displayed, as shown in FIG. 6C, the electronic device 100 may display a notification window 630 by moving it to a lowermost portion of the display unit 170. In this case, the displayed notification windows 610, 620, and 630 of FIGS. 6A, B, and C may display a part of content of a text message for a credit card usage history.

The electronic device 100 may execute a function of the notification event when the notification windows 610, 620, and 630 are selected in FIGS. 6A to C. For example, since the notification event is the notification event for informing the use of the credit card, the electronic device 100 may display total content of the text message for the credit card history on the display unit 170.

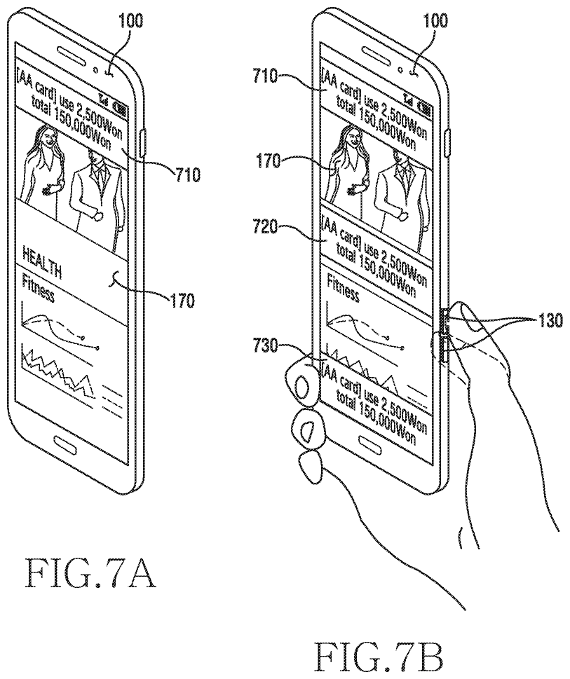

FIG. 7 illustrates an exemplary screen of an electronic device for controlling a notification window by manipulating an input unit of the electronic device according to an embodiment of the present disclosure.

Referring to FIG. 7, when the notification event for informing the credit card usage occurs in a state where a health related application execution screen is displayed on the display unit 170, as shown in FIG. 7A, the electronic device 100 may display a notification window 710 of the notification event at a designated position of the display unit 170. The electronic device 100 may identify that an input is achieved in the input unit 130, e.g., a volume up/down button, disposed to a lateral side of the electronic device 100 in a state where the notification window 710 is displayed. When the input is achieved in the volume up/down button, the electronic device 100 may identify that the input is a movement input for the notification window 710.

The electronic device 100 may identify a type of a button in which the input is achieved. In a case where the notification window 710 is located at an uppermost portion of the display unit 170, when a first input is achieved in the volume down button, as shown in FIG. 7B, the electronic device 100 may display a notification window 720 by moving it to a center point of the display unit 170. When an additional input is achieved in the volume down button in a state where the notification window 720 is displayed at the center point of the display unit 170, as shown in FIG. 7B, the electronic device 100 may display a notification window 730 by moving it to a lowermost portion of the display unit 170.

In a case where the notification window 710 is located at the uppermost portion of the display unit 170, when an input is achieved in the volume up button, the electronic device 100 may display a message indicating that the notification window 710 cannot be moved or may end the displaying of the notification window 710. In this case, the notification windows 710, 720, and 730 shown in FIGS. 7A and B may display a part of content of a text message for a credit card usage history. The electronic device 100 may execute a function of the notification event when the notification windows 710, 720, and 730 are selected in FIGS. 7A and B. For example, since the notification event is the notification event for informing the use of the credit card, the electronic device 100 may display total content of the text message for the credit card history on the display unit 170.

Although it is described that the electronic device 100 displays a notification window at any one position among uppermost, center, and lowermost positions of the display unit 170 when the input is achieved in the volume up/down button, an embodiment of the present disclosure is not limited thereto. The electronic device 100 may gradually move the notification window towards the lowermost portion from the uppermost portion or towards the uppermost portion from the lowermost portion of the display unit 170 by the number of times the input is achieved in the volume up/down button.

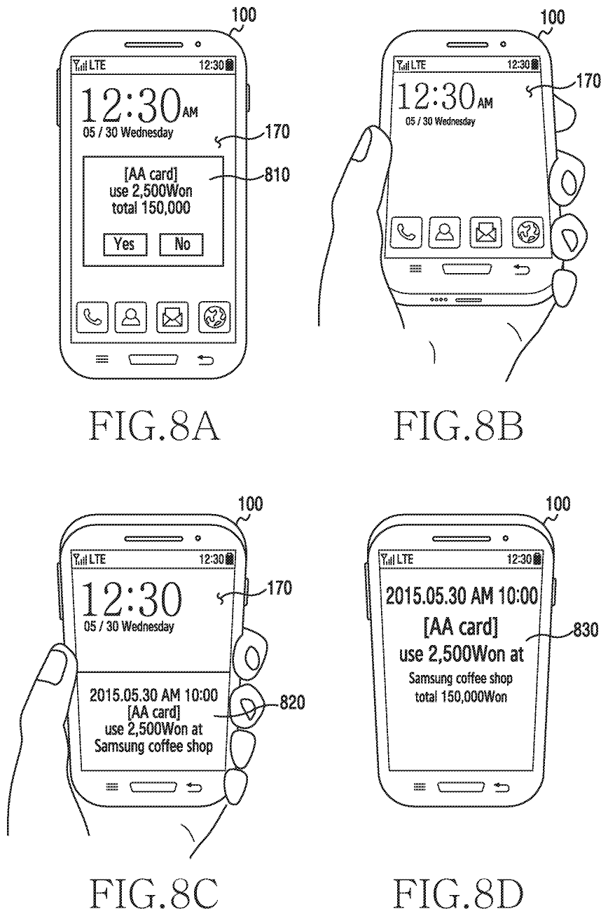

FIG. 8 illustrates an exemplary screen of an electronic device for executing a notification window on the basis of a tilt of the electronic device according to an embodiment of the present disclosure.

Referring to FIG. 8, when a notification event occurs to inform the use of a credit card in a state where an idle state is displayed on the display unit 170, the electronic device 100 may display a notification window 810 of the notification event at a designated position of the display unit 170 as shown in FIG. 8A. The electronic device 100 may identify that the tilt of the electronic device 100 is changed in a state where the notification window 810 is displayed. When the tilt of the electronic device 100 is changed in the state where the notification window 810 is displayed, the electronic device 100 may identify that an input is an execution input for the notification window 810.

When the electronic device 100 is tilted backwards as shown in FIG. 8B in a state where the user grips the electronic device 100, for example, when a lower portion of the electronic device 100 is tilted towards the user, the electronic device 100 may end the displaying of the notification window 810. When the electronic device 100 is tilted forwards as shown in FIG. 8C in a state where the notification window 810 of the notification event is displayed at a designated position of the display unit 170 as shown in FIG. 8A, for example, when an upper portion of the electronic device 100 is tilted towards the user, the electronic device 100 may perform a function of the notification event. For example, since the notification event is the notification event for informing the use of the credit card, the electronic device 100 may display total content 820 of the text message for the credit card history at a lower end of on the display unit 170 in a multi-window form.

When the electronic device 100 is tilted forwards as shown in FIG. 8D in a state where the notification window 810 of the notification event is displayed at the designated position of the display unit 170 as shown in FIG. 8A, the electronic device 100 may perform the function of the notification event. For example, since the notification event is the notification event for informing the use of the credit card, the electronic device 100 may display total content 830 of the text message for the credit card history on the entirety of the display unit 170.

In addition, the notification event may occur in a state where a specific application is executed in the electronic device 100, and it may be detected that the electronic device 100 is tilted forwards as shown in FIG. 8C. In this case, the electronic device 100 may display a function corresponding to the notification event at the lower end of the display unit 170 in the multi-window form in a state where an execution screen of the specific application is displayed. Although not shown, when the tilt of the electronic device 100 is changed to the left/right in a state where the notification window 810 of the notification event is displayed, the electronic device 100 may change a position of the notification window 810, or may perform the function of the notification event.

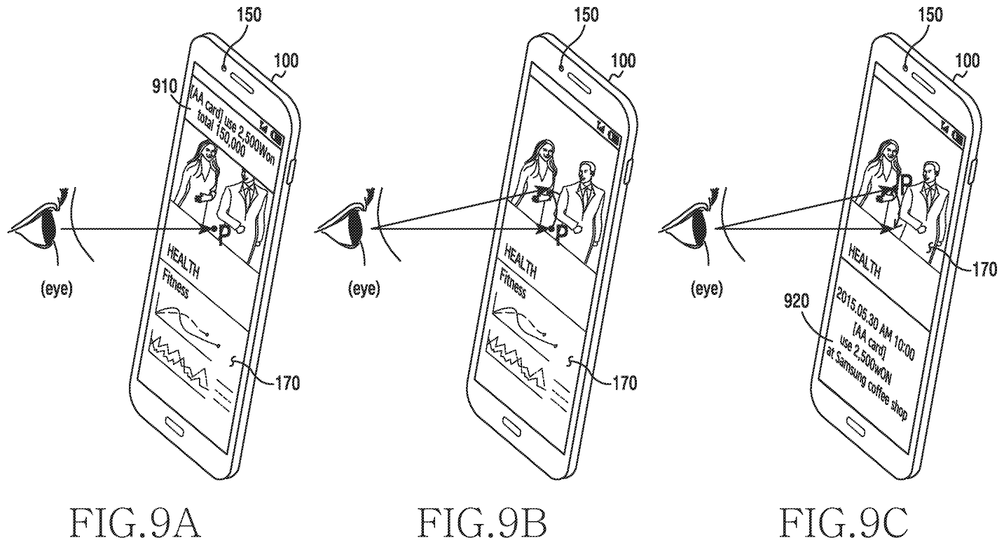

FIG. 9 illustrates an exemplary screen of an electronic device for executing a notification window on the basis of a user's gaze movement according to an embodiment of the present disclosure.

Referring to FIG. 9, when a notification event for informing the use of a credit card occurs in a state where a health related application execution screen is displayed on the display unit 170, the electronic device 100 may display a notification window 910 of the notification event at a designated position of the display unit 170 as shown in FIG. 9A. The electronic device 100 may activate the camera 150 disposed to a front side of the electronic device 100 to acquire a user's face image when the notification event occurs. The electronic device 100 may identify a user's gaze position P from the acquired face image. The electronic device 100 may identify that the user's gaze position is changed within a threshold time in a state where the notification window 910 is displayed. When the user's gaze position is changed, the electronic device 100 may identify that an input is an execution input for the notification window 910.

When it is identified that the user's gaze position P is moved towards an upper portion of the display unit 170 within a threshold time from a time when the notification event occurs as shown in FIG. 9B, the electronic device 100 may end the displaying of the notification window 910. When it is identified that the user's gaze position P is moved towards a lower portion of the display unit 170 within the threshold time from a time when the notification event occurs as shown in FIG. 9C, the electronic device 100 may perform the function of the notification event. For example, since the notification event is the notification event for informing the use of the credit card, the electronic device 100 may display total content 920 of the text message for the credit card history at a lower end of on the display unit 170 in a multi-window form.

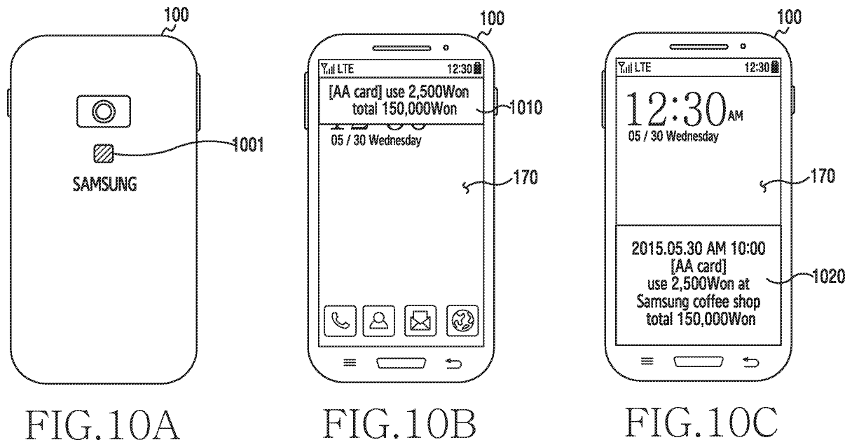

FIG. 10 illustrates an exemplary screen of an electronic device for executing a notification window in accordance with an input achieved in a specific sensor of the electronic device according to an embodiment of the present disclosure.

Referring to FIG. 10, as shown in FIG. 10A, a sensor 1001 may be disposed to a rear side of the electronic device 100 to detect a user's input. In this case, the sensor 1001 may be included in the sensor unit 120 as a specific sensor such as an illumination sensor, a pressure sensor, or the like. Upon occurrence of a notification event for informing the use of a credit card in a state where an idle screen is displayed on the display unit 170, the electronic device 100 may display a notification window 1010 of the notification event at a designated position of the display unit 170 as shown in FIG. 10B.

Upon receiving an execution signal for executing the notification window 1010 from the sensor 1001 in the state where the notification window 1010 is displayed, the electronic device 100 may perform a function of the notification event as shown in FIG. 10C. For example, since the notification event is the notification event for informing the use of the credit card, the electronic device 100 may display total content 1020 of the text message for the credit card history at a lower end of on the display unit 170 in a multi-window form. Upon receiving a signal for ending the notification window 1010 from the sensor 1001, the electronic device 100 may end the displaying of the notification window 1010 displayed at a specific position of the display unit 170.

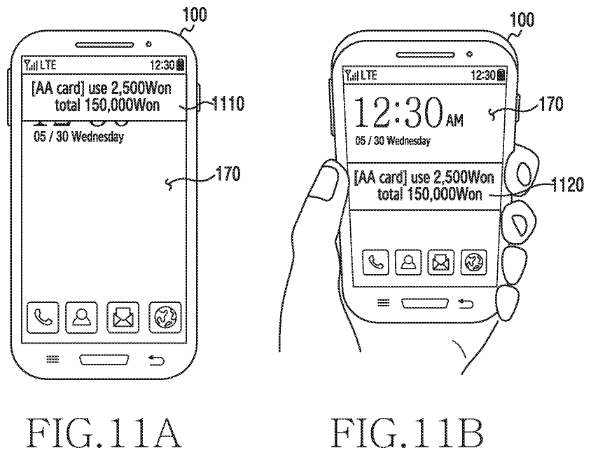

FIG. 11 illustrates an exemplary screen of an electronic device for controlling a notification window on the basis of a tilt and grip of the electronic device according to an embodiment of the present disclosure.

Referring to FIG. 11, when a notification event occurs to inform the use of a credit card in a state where an idle state is displayed on the display unit 170, the electronic device 100 may display a notification window 1110 of the notification event at a designated position of the display unit 170 as shown in FIG. 11A. The electronic device 100 may identify that the tilt of the electronic device 100 is changed in a state where the notification window 810 is displayed. When the tilt of the electronic device 100 is changed in the state where the notification window 1110 is changed, the electronic device 100 may identify a thumb position of a user who grips the electronic device 100.

When the electronic device 100 is tilted forwards as shown in FIG. 11B in a state where the notification window 1110 of the notification event is displayed at the designated position of the display unit 170 as shown in FIG. 11A, for example, when an upper portion of the electronic device 100 is tilted towards a user, the electronic device 100 may identify the thumb position of the user who grips the electronic device 100. The electronic device 100 may display a notification window 1120 by moving it to the identified thumb position. Upon selecting the moved notification window 1120, the electronic device 100 may perform the function of the notification event. For example, since the notification event is the notification event for informing the use of the credit card, the electronic device 100 may display total content of the text message for the credit card history on the entirety or part of the display unit 170. In this case, in a state where an idle screen or an execution screen of a specific application being executed is displayed on the display unit 170, the electronic device 100 may display the function corresponding to the notification event at a lower end of the display unit 170.

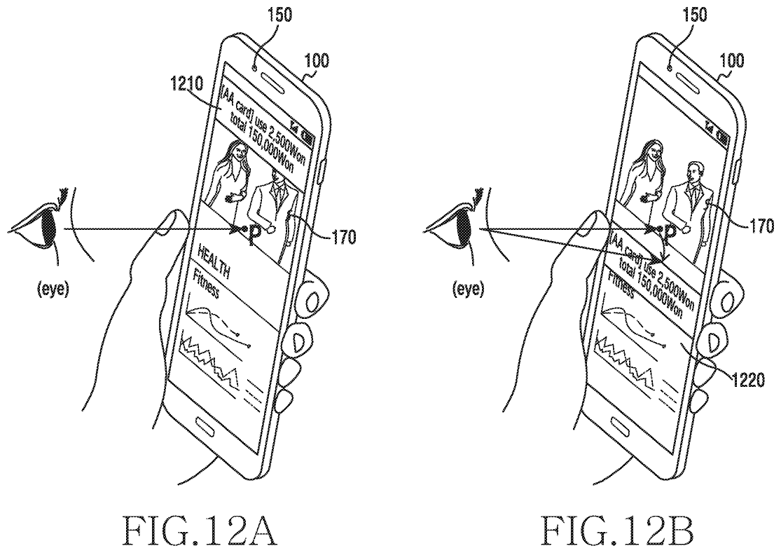

FIG. 12 illustrates an exemplary screen of an electronic device for controlling a notification window on the basis of a user's gaze movement and a grip of the electronic device according to an embodiment of the present disclosure.

Referring to FIG. 12, when the notification event for informing the credit card usage occurs in a state where a health related application execution screen is displayed on the display unit 170, as shown in FIG. 12A, the electronic device 100 may display a notification window 1210 of the notification event at a designated position of the display unit 170. The electronic device 100 may activate the camera 150 disposed to a front side of the electronic device 100 to acquire a user's face image when the notification event occurs. The electronic device 100 may identify a user's gaze position P from the acquired face image. The electronic device 100 may identify that the user's gaze position is changed within a threshold time in a state where the notification window 1210 is displayed. When the user's gaze position is changed, the electronic device 100 may identify the thumb position of the user who grips the electronic device 100.

When it is identified that the user's gaze position P is moved towards a lower portion of the display unit 170 within the threshold time from a time when the notification event occurs as shown in FIG. 12B, the electronic device 100 may identify the thumb position of the user who grips the electronic device 100. The electronic device 100 may display a notification window 1120 by moving it to the identified thumb position. Upon selecting the moved notification window 1120, the electronic device 100 may perform the function of the notification event. For example, since the notification event is the notification event for informing the use of the credit card, the electronic device 100 may display total content of the text message for the credit card history on the entirety or part of the display unit 170. In this case, the electronic device 100 may display a function corresponding to the notification event at the lower end of the display unit 170 in the multi-window form in a state where an execution screen of a health related application being executed is displayed on the display unit 170.

According to an embodiment, a method of operating an electronic device may include detecting occurrence of a notification event, displaying a notification window for the detected notification event at a designated position of a display screen, identifying an input detected in the electronic device, and controlling the notification window in the display screen in accordance with the input.

The controlling of the notification window may include moving and displaying the notification window in accordance with the input when the input is a movement input for the notification window.

The moving and displaying of the notification window may include reducing and displaying the notification window. The moving and displaying of the notification window may include displaying the notification window as an icon.

The movement input for the notification window may include any one of a finger position detected at a time of gripping the electronic device 100, flipping occurring in the electronic device 100, and an input achieved by a physical key provided in the electronic device 100.

The method may further include performing a function corresponding to the notification event when the notification window is selected.

The controlling of the notification window may perform the function corresponding to the notification event when the input is an execution input for the notification window. The execution input for the notification window may be a change in a tilt detected in the electronic device 100. The electronic device 100 may further include the camera 150 which acquires an image for a user, and the execution input for the notification window may be a change in a user's gaze movement identified from the image. The electronic device 100 may further include a sensor, and the controlling of the notification window may further include performing a function corresponding to the notification event when the input is an execution signal detected in the sensor.

On the other hand, embodiments of the present disclosure disclosed in the specification and drawings are presented only as a specific example for clarity and are not intended to limit the scope of the disclosure. That is, it is apparent to those of ordinary skill in the art to which the disclosure pertains that other modifications based on the technical concept of the present disclosure are possible.

1. A method of operating an electronic device, the method comprising:
detecting occurrence of a notification event;
displaying a notification window for the detected notification event at a designated position of a display screen;
identifying an input detected in the electronic device; and
controlling the notification window in the display screen in accordance with the input.

2. The method of claim 1, wherein the controlling of the notification window comprises moving and displaying the notification window in accordance with the input when the input is a movement input for the notification window.

3. The method of claim 2, wherein the moving and displaying of the notification window comprises:
reducing and displaying the notification window.

4. The method of claim 2, wherein the movement input for the notification window comprises any one of a finger position detected at a time of gripping the electronic device, flipping occurring in the electronic device, and an input achieved by a physical key provided in the electronic device.

5. The method of claim 1, wherein the controlling of the notification window comprises:
performing the function corresponding to the notification event when the input is an execution input for the notification window.

6. The method of claim 5, wherein the execution input for the notification window is a change in a tilt detected in the electronic device.

7. The method of claim 1,
wherein the electronic device further comprises a sensor, and
wherein the controlling of the notification window comprises performing a function corresponding to the notification event when the input is an execution signal detected in the sensor.

8. An electronic device comprising:
a display which displays a display screen; and
a controller which detects occurrence of a notification event, displays a notification window for the notification event at a designated position of a display screen, identifies an input detected in the electronic device, and controls the notification window in the display screen in accordance with the input.

9. The electronic device of claim 8, wherein the controller moves the notification window in accordance with the input when the input is a movement input for the notification window.

10. The electronic device of claim 9, wherein the controller reduces the notification window while moving the notification window.

11. The electronic device of claim 9, wherein the movement input for the notification window comprises any one of a finger position detected at a time of gripping the electronic device, flipping occurring in the electronic device, and an input achieved by a physical key provided in the electronic device.

12. The electronic device of claim 8, wherein the controller performs a function corresponding to the notification event when the input is an execution input for the notification window.

13. The electronic device of claim 12, wherein the execution input for the notification window is a change in a tilt detected in the electronic device.

14. The electronic device of claim 12, further comprising a camera which acquires images for a user, wherein the execution input for the notification window is a user's gaze movement identified from the images.

15. The electronic device of claim 8, further comprising a sensor, wherein the controller performs a function corresponding to the notification event when the input is an execution signal detected in the sensor.

16. The method of claim 2, wherein the moving and displaying of the notification window comprises:
displaying the notification window as an icon.

17. The method of claim 1, further comprising:
performing a function corresponding to the notification event when the notification window is selected.

18. The method of claim 5,
wherein the electronic device further comprises a camera for acquiring a user image, and
wherein the execution input for the notification window is a change in a user's gaze movement identified from the user image acquired through the camera.

19. The electronic device of claim 9, wherein the controller changes the notification window to an icon while moving the notification window.

20. The electronic device of claim 8, wherein the controller performs a function corresponding to the notification event when the notification window is selected.
